(19) United States
(12) Patent Application Publication
(10) Pub. No.: US 2010/0319606 A1
(43) Pub. Date: Dec. 23, 2010

(54) CHEMICAL TAGGING INDICATORS AND METHOD TO LOCATE OVERHEATED SPOTS IN LIQUID-FILLED ELECTRICAL DEVICES

(75) Inventors: Anatoly Shkolnik, Kiryat Motzkin (IL); Leonid Shapovalov, Haifa (IL); Oleg Figovsky, Haifa (IL); Olga Birukov, Haifa (IL); Alex Trossman, Haifa (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignees: ISRAEL ELECTRIC CORPORATION, Haifa (IL); POLYMATE LTD., Haifa (IL)

(21) Appl. No.: 12/867,761

(22) PCT Filed: Feb. 21, 2008
(86) PCT No.: PCT/IL08/00224

§ 371 Date: Aug. 16, 2010

(51) Int. Cl. G01N 31/22; C08F 20/10; C08L 33/10; C08L 35/04

(52) U.S. Cl. 116/206; 526/319; 524/560; 524/502

(57) ABSTRACT

A method for identifying overheated spots in liquid-filled electrical devices, comprising the steps of: a) determining the locations of potentially overheatable spots in said device and mapping said locations; b) positioning a tag consisting of one or more chemical indicators on potentially overheatable spots in said devices, wherein when said tags are exposed to a given high temperature, they are depolymerized into thermal degradation products which are diffused into the liquid; c) identifying the thermal degradation products by analytical methods; and d) locating the overheated places according to the identified thermal degradation products and the map of locations of said tags; wherein the tags comprise polymers and copolymers, which are substantially absent from the liquid of the device at normal working conditions.

### FIELD OF THE INVENTION

The invention relates to oil-cooling electrical devices having a potentially overheating danger, and method for identifying the overheated spots using chemical indicators.

### BACKGROUND OF THE INVENTION

Nowadays, diagnostics of an overheated place in electrical oil-filled devices are made according to the international standard IEC 60567 [1992, Guide for the sampling of gases and of oil from oil-filled electrical equipment and for the analysis of free dissolved gases]. Said diagnoses are made by chromatography method for the identification of the contents of gases dissolved in the oil, e.g. CH₄, C₂H₆, CO, CO₂, H₂, C₂H₂, etc. Decomposition of oil or insulation materials under the action of increasing temperatures (200° C. and above) indicates the presence of an overheated place in an electrical device. On the basis of the data of the chemical analysis, if the contents of dissolved gases is above allowable concentrations, the device is switched off. Then, with the help of electrical and visual methods, the overheated place is located and repaired.

This method does not allow for a precise determination of the location of the overheated spot in the device and it is not effective for an early diagnostics of developing damages. The shortcomings of the existing method are: I) the delay of information about ongoing overheating of oil in potentially dangerous spots of an electrical device; ii) the complexity of identifying a damaged location within the device; iii) the significant time and labor required to locate and eliminate the defect; and iv) the interpretation of the results of the analysis need to be made in accordance with IEC 60599 [1999, Mineral oil-impregnated electrical equipment in service, Guide to the interpretation of dissolved and free gases analysis], which provides information only about possible existing defects, without any identification of the specific location where those defects occurred.

In search for an efficient method for identifying damages in overheated spots in liquid-filled electrical devices, the inventors have developed chemical indicators, which are suitable to be placed on potential trouble spots, and release specific substances when exposed to predefined temperatures.

The invention overcomes the abovementioned disadvantages of prior art methods used for the identification of an overheated place, and is advantageous over the known method, inasmuch as it provides for the early diagnosis of ongoing overheating, as well as for the location of the overheated spot through the identification of specific substances in the oil, released by the chemical indicator, formerly located on the damaged place.

It is an object of the present invention to provide chemical indicators, which liberate specific substances at given temperatures. The appearance of said substances indicates the presence of an overheated spot and enables the easy identification of the location where damage has occurred.

It is another object of the present invention to provide means for the identification of damage in overheated spots, which are unreachable in the regular use of the device.

Other objects and advantages of the present invention will appear as the description proceeds.

### SUMMARY OF THE INVENTION

In search for efficient method for the identification of damaged places in liquid-filled electrical devices, the inventors developed chemical indicators, which are placed on said potential places, and which release substances in response to excess heat. Said substances are then identified and point to the location of the damaged place.

Thus, in a first aspect, the invention relates to a method for identifying overheated spots in liquid-filled electrical devices, comprising the steps of: a) determining the locations of potentially overheatable spots in said device and mapping said locations; b) positioning a tag consisting of one or more chemical indicators on potentially overheatable spots in said devices, wherein when said tags are exposed to a given high temperature, they are depolymerized into thermal degradation products which are diffused into the liquid; c) identifying the thermal degradation products by analytical methods; and d) locating the overheated places according to the identified thermal degradation products and the map of locations of said tags; wherein the tags comprise polymers and copolymers, which are substantially absent from the liquid of the device at normal working conditions.

The invention further relates to said method, wherein in step (b), the tags are mounted on a heat-conducting elongation device, attached to a potentially overheatable place.

More specifically, the invention relates to a method for identifying overheated spots in liquid-filled electrical devices, wherein the liquid is an organic liquid, e.g. oil.

In a further aspect, the invention provides specific chemical indicators (tags) comprising a polymer and/or copolymer, which are depolymerized when exposed to a temperature of from about 150° C. to about 450° C. Said polymer may have a quaternary carbon atom. More particularly, said polymer is selected from among methyl-, ethyl-, propyl-, isopropyl-, butyl-, isobutyl-, methacrylonitril-methacrylates. Said tags may optionally be encapsulated.

The invention further relates to a method for identifying overheated places in liquid-filled electrical devices, wherein the tags comprise a plurality of chemical indicators, each of which is depolymerized at a specific given temperature comprised between about 150° C. to about 450° C. Said tags may optionally be microencapsulated. Such microencapsulated tags have the ability to degradate in oil at temperatures greater than 200° C.

The method of the invention may use various analytical methods for the identification of the dissolved substances in the liquid from the device, e.g. chromatography or any other analytical method. Said analysis is carried out periodically when monitoring a specific device. Said identification is carried out according to a map of locations of the tags.

The invention further relates to a method for the synthesis of the tags of the invention, comprising the steps of: a) mixing an epoxy resin and polyamines; b) mixing the mixture of step (a) with the polymer and pouring the mixture into a mould; c) raising the temperature; and d) further heating the indicator for removing monomers residues.

### BRIEF DESCRIPTION OF THE DRAWINGS

The above and other characteristics and advantages of the invention will be further appreciated through the following examples, and with reference to the appended drawings, wherein:

FIG. 1 is a scheme that illustrates the operation of the chemical indicator;

FIG. 2 schematically illustrates the application of the chemical indicators on potentially overheated spots in an electrical device; and

FIG. 3 is the scheme of a laboratory installation for the testing of chemical indicators.

### DETAILED DESCRIPTION OF THE INVENTION

The invention relates to materials useful as chemical indicators and their synthesis on the base of network polymers and copolymers that can be depolymerized. More specifically, the invention relates to such indicators based on polymers with a quaternary carbon atom.

Furthermore, the invention provides a method for the identification of overheated spots in liquid-filled electrical devices, more specifically, oil-filled electrical devices, by using the chemical indicators of the invention. The chemical indicators and the substances liberated from them are: i) stable against the action of oil, electrical and magnetic fields; ii) do not influence dielectric, physical and chemical properties of the oil; iii) are inert to insulation and other materials, used in the design of electrical devices.

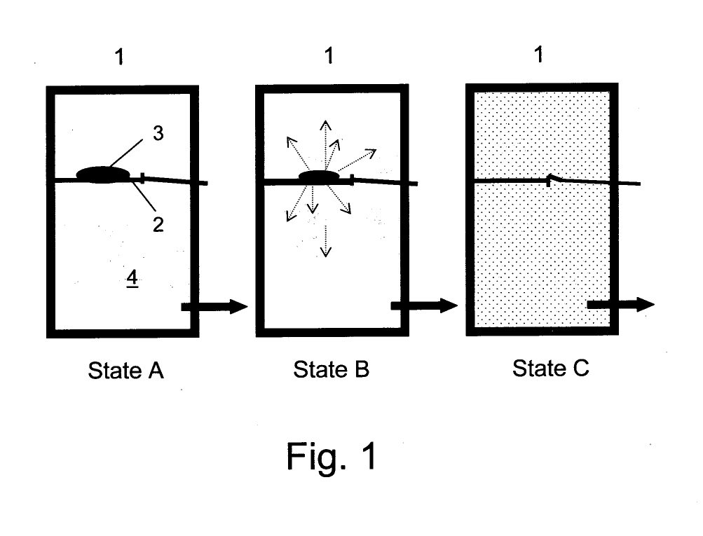

The use of the chemical indicators of the invention is illustrated in FIG. 1, wherein 1 is an electrical device; 2 is a potentially overheatable spot inside the electric device; 3 is a chemical Indicator (Mᵢ); and 4 is the mineral oil. State A is the normal mode of work of electrical device 1 (T≦80° C.). State B is a state where the temperature on the potential overheating spot is raised. State C is the state in which a complete depolymerization of the chemical indicator and spreading of monomer in the whole oil volume takes place (T≧150−450° C.), followed by sample analysis. As long as the temperature of the device is below 80° C., the chemical indicator is stable and intact; if the temperature on the contact of the electric device exceeds a predetermined temperature (150-450° C.), the chemical indicator “Mᵢ” liberates into the filling liquid a typical component-specific substance, which serves as a unique chemical indicator for that component, so that the analysis of the filling liquid of a liquid-filled electrical devise, which has Mₙ indicators, on different potentially dangerous overheat places, enables the identification of each of the component-specific substances, referred to herein as chemical indicator Xᵢ; this means that all the chemical indicators Mᵢ are tested simultaneously during repair/maintenance.

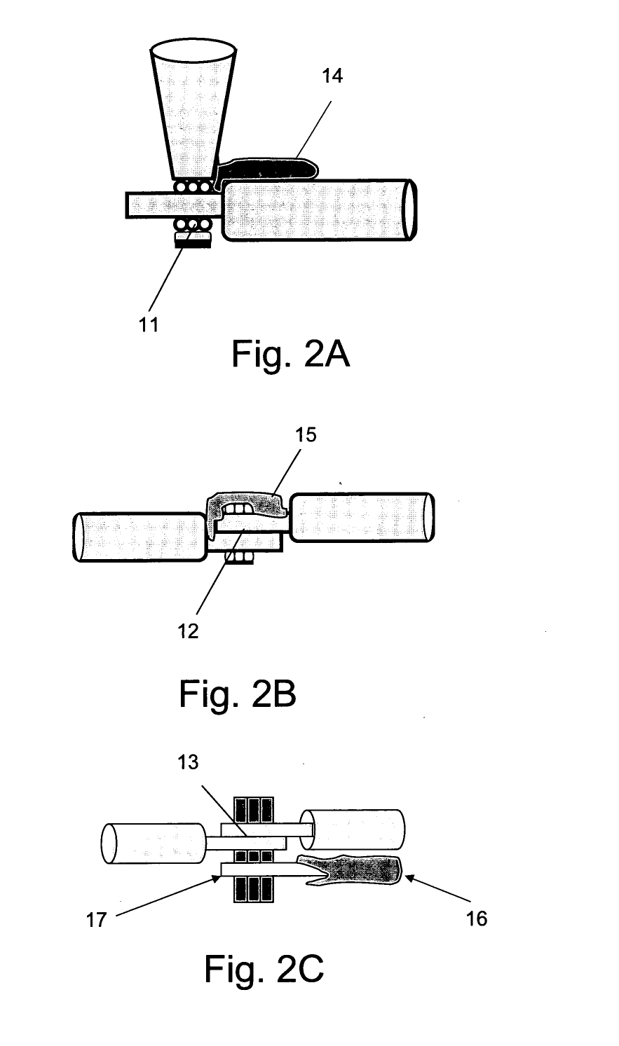

The chemical indicators are put on potential overheatable places of the liquid-filled electrical device, according to a map appropriate for each specific device, by the manufacturer or during maintenance of the device. Three examples of positioning of chemical indicators on contacts of the electrical device are shown on FIG. 2, where numerals 11, 12 and 13 are the contacts and 14, 15 and 16 are the indicators. Numeral 17 indicates a thermal conductor.

When damage occurs at an electrical connection, or at another location that is marked with a chemical indicator, there is an increase of temperature up to a given temperature, which causes the chemical indicator to liberate a recognizable substance into the liquid. According to the map of chemical indicators and the data of the chemical analyses, the identification of an overheated spot becomes possible, and appropriate measures for dealing with the problem are taken.

The chemical indicators of the invention are based on polymers or copolymers, which are decomposed in the temperature range of from 200° C. to about 450° C. As a result of the thermal decomposition, the polymers are decomposed into the monomers. The thermal decomposition of the polymers is a chain radical process:

˜CH₂—CHX—CH₂—CHX˜,

where X is a heteroatom.

The decomposition of the polymer molecule begins at a random location:

˜CH₂—CHX—CH₂—CHX˜→˜CH₂—CHX+CH₂—CHX˜,

resulting in the generation of two free radicals.

Chemical compositions suitable for use as chemical indicators according to the invention are polymers and copolymers that have a quaternary carbon atom and can be depolarized at high temperatures, producing monomers (e.g. polymethacrylate, poly-α-methylstyrol, polymethacrylonitrile, etc). However, linear polymers might be soluble in the liquid of the device (typically, mineral oil), rending them useless as chemical indicators. This difficulty can be resolved by using copolymers or using micro encapsulation methods, in which case, the polymer is covered with a non-soluble shell.

It is preferable to place the chemical indicator directly on the potentially overheated spot. However, as certain potentially overheated spots are not accessible or the chemical indicator cannot be placed onto it because of lack of room or for any other reason, the invention also provides a method for placing said indicators on a heat-conducting elongation device, which is connected at one end to the spot to be monitored. When this method is used, the length and conductivity of the elongation device, as well as the heat-loss along the elongation device, are taken into consideration when choosing the chemical indicator to be used, e.g. to liberate an indicator at 200° C. at an unreachable overheat place, when a 50° C.-loss is expected along the elongation device, one would need to use a chemical indicator that releases substances into the liquid-filled electrical device at a temperature of 150° C.

The invention also provides for the preparation of chemical indicators with variable desired decomposition-temperature range, as well as a desired velocity of the depolymerization.

### Synthesis of the Chemical Indicators

Polymerization of the chemical indicators may be initiated by a variety of known means such as heat, chemical means or photochemical initiators. Thus, in order to induce the curing of polymethacrylate indicators, a free radical catalyst may be incorporated therein. The organic peroxide initiators such as methylethyl-ketoneperoxide, t-butylperoctoat, isopropyl-percarbonate, cumenehydroperoxide, dicumylperoxude, and especially dibenzoylperoxide, are illustrative and non-limitative examples of preferred initiators. The ability of the initiator to cure indicators may be enhanced through to use of activators or accelerators such as tertiary aromatic amines, e.g. N,N-dimethyl-p-toluidine. The desired curing rate dictates the amounts of the catalyst and of the free radical catalyst to be used, which may both be selected from 0.5 to 5.0% by weight of the polymerisable components.

The polymerization of the polymethacrylates for chemical indicators may also be initiated by ultra-violet or visible light, using known light-activated polymerization initiators, such as camphorquinone, benzoin-benzil and the like. Additionally, the above photoinitiators may be used with activators such as tertiary aliphatic or aromatic amines, such as N,N,N,N-tetramethylen-diamine (TEMED) or dimethylaminoethyl methacrylate (Ageflax-FM-1).

In the polymerization process, the amount of initiator used is 0.1-0.25% and of activator is 0.1-0.5% by weight of the polymerisable components. Due to the presence of residue monomers, it is a necessary, as a final step of the indicators preparation, to remove said monomers from the indicators, by heating of indicators and evaporation of said monomers.

### Example 1

95 g Methylmethacrylate, 5 g Etoxylated₃ Bisphenol A Diacrylate (SR-349, Sartomer Company), and 2 g Di-Benzoyl Peroxide were thoroughly mixed and dissolved during 1 hour at 40° C. 2 g N,N-Dimethyl-p-toluidine was added to the mixture, with good mixing for 2 minutes. The mixture was put into a mould, and kept in the mould at room temperature for 1 hour. The temperature was then raised to 80° C. and the reaction mixture was kept at this temperature for 8 hours. The indicator was heated to 110° C. (removing of monomers residue) to constant weight. The rate of depolymerisation was determined by chromatography and weight methods. The results are summarized in Table 1.

TABLE 1

| Temperature on | | | |
|---|---|---|---|
| the electrical | | Monomer Yield | Rate of |
| contact, ° C. | Time | to mineral Oil | Depolymerization % |
| 100 ± 10 | 2 months | Methylmethacrylate | 0 |
| 150 ± 10 | 2 months | ″ | 0 |
| 240 ± 10 | 8 hours | ″ | 60 |
| 300 ± 30 | 4 hours | ″ | 95 |

### Example 2

93 g Ethylmethacrylate, 7 g Etoxylated₂ Bisphenol A Dimethacrylate (SR-348, Sartomer Company), and 2 g Di-Benzoyl Peroxide were thoroughly mixed and dissolved during 1 hour at 40° C. To this mixture, 2 g N,N-Dimethyl-p-toluidine was added with good mixing for 2 minutes. The mixture was put into a mould, and kept in the mould at room temperature for 1 hour. The temperature was then raised to 80° C. and the reaction mixture was kept at this temperature for 8 hours. The indicator was maintained at temperature of 120° C. (removing of monomers residue) to constant weight. The rate of depolymerisation was determined by chromatography and weight methods. The results are summarized in Table 2.

TABLE 2

| Temperature on | | | |
|---|---|---|---|
| the electrical | | Monomer Yield | Rate of |
| contact, ° C. | Time | to mineral Oil | Depolymerization % |
| 100 ± 10 | 2 months | Ethylmethacrylate | 0 |
| 150 ± 10 | 2 months | ″ | 0 |
| 240 ± 10 | 8 hours | ″ | 70 |
| 300 ± 30 | 4 hours | ″ | 93 |

### Example 3

92 g Isobutyl methacrylate, 8 g Ethoxylated₄ Pentaerythritol Tetraacrylate (SR-494, Sartomer Company), and 2 g Di-Benzoyl Peroxide were thoroughly mixed and dissolved during 1 hour at 40° C. To this mixture 2 g N,N-Dimethyl-p-toluidine (accelerator) was added, with good mixing for 2 minutes. The mixture was put into a mould, and kept in the mould at room temperature for 1 hour. The temperature was then raised to 80° C. and the reaction mixture was kept at this temperature for 8 hours. The indicator was heated at 160° C. (removing of monomers residue) to constant weight. The rate of depolymerisation was determined by chromatography and weight methods. The results are summarized in Table 3.

TABLE 3

| Temperature on | | | |
|---|---|---|---|
| the electrical | | Monomer Yield | Rate of |
| contact, ° C. | Time | to mineral Oil | Depolymerization % |
| 100 ± 10 | 2 months | Isobutylmethacrylate | 0 |
| 150 ± 10 | 2 months | ″ | 0 |
| 240 ± 10 | 8 hours | ″ | 55 |
| 300 ± 30 | 4 hours | ″ | 92 |

### Example 4

90 g Butylmethacrylate, 10 g Etoxylated₂ Bisphenol A Dimethacrylate (SR-348, Sartomer Company), and 2 g Di-Benzoyl Peroxide were thoroughly mixed and dissolved during 1 hour at 40° C. To this mixture 2 g N,N-Dimethyl-p-toluidine was added with good mixing for 2 minutes. The mixture was poured into a mould, and kept in it at room temperature for 1 hour. The temperature was then raised to 80° C. and the reaction mixture was kept at this temperature for 8 hours. The indicator was maintained at 160° C. (removing of monomers residue) to constant weight. The rate of depolymerisation was determined by chromatography and weight methods. The results are summarized in Table 4.

TABLE 4

| Temperature on | | | |
|---|---|---|---|
| the electrical | | Monomer Yield | Rate of |
| contact, ° C. | Time | to mineral Oil | Depolymerization % |
| 100 ± 10 | 2 months | Butylmethacrylate | 0 |
| 150 ± 10 | 2 months | ″ | 0 |
| 240 ± 10 | 8 hours | ″ | 65 |
| 300 ± 30 | 4 hours | ″ | 90 |

### Example 5

90 g Methacrylonitrile, 10 g aromatic urethane acrylate oligomer (CN-970 E60, Sartomer company), and 2 g Di-Benzoyl Peroxide were thoroughly mixed and dissolved during 1 hour at 40° C. To this mixture, 2 g N,N-Dimethyl-p-toluidine was added with good mixing for 2 minutes. The mixture was poured into a mould, and kept in it at room temperature for 1 hour. The temperature was then raised to 60° C. and the reaction mixture was kept at this temperature for 8 hours. The indicator was maintained at 90° C. (removing of monomers residue) to constant weight. The rate of depolymerisation was determined by chromatography and weight methods. The results are summarized in Table 5.

TABLE 5

| Temperature on | | | |
|---|---|---|---|
| the electrical | | Monomer Yield | Rate of |
| contact, ° C. | Time | to mineral Oil, | Depolymerization % |
| 100 ± 10 | 2 months | Methacrylonitrile | 0 |
| 150 ± 10 | 2 months | ″ | 0 |
| 200 ± 10 | 8 hours | ″ | 70 |
| 250 ± 10 | 4 hours | ″ | 90 |

### Example 6

Manufacturing of chemical indicators by microencapsulation methods. The product is an encapsulated polymer based on polymethacrylates. The production line for said manufacturing consists of two stages:
1) mixing components; and
2) polymerization.

12.6 g Epoxy Resin YD-128 (Kukdo) and 2.4 g Metha-Xylylenediamine were thoroughly mixed and dissolved. This mixture was added to 85 g powder of poly(methyl-methacrylate) with good mixing for 10 minutes. The mixture was poured into a mould, and kept in it at room temperature for 48 hours. Then the temperature was raised to 80° C. and the reaction mixture was kept at this temperature for 16 hours. The rate of depolymerisation was determined by chromatography and weight methods. The results are summarized in Table 6.

TABLE 6

| Temperature on | | | |
|---|---|---|---|
| the electrical | | Monomer Yield | Rate of |
| contact, ° C. | Time | to mineral Oil, | Depolymerization % |
| 100 ± 10 | 2 months | Methylmethacrylate | 0 |
| 150 ± 10 | 2 months | ″ | 0 |
| 250 ± 10 | 24 h | ″ | 10 |
| 300 ± 30 | 15 h | ″ | 85 |

### Example 7

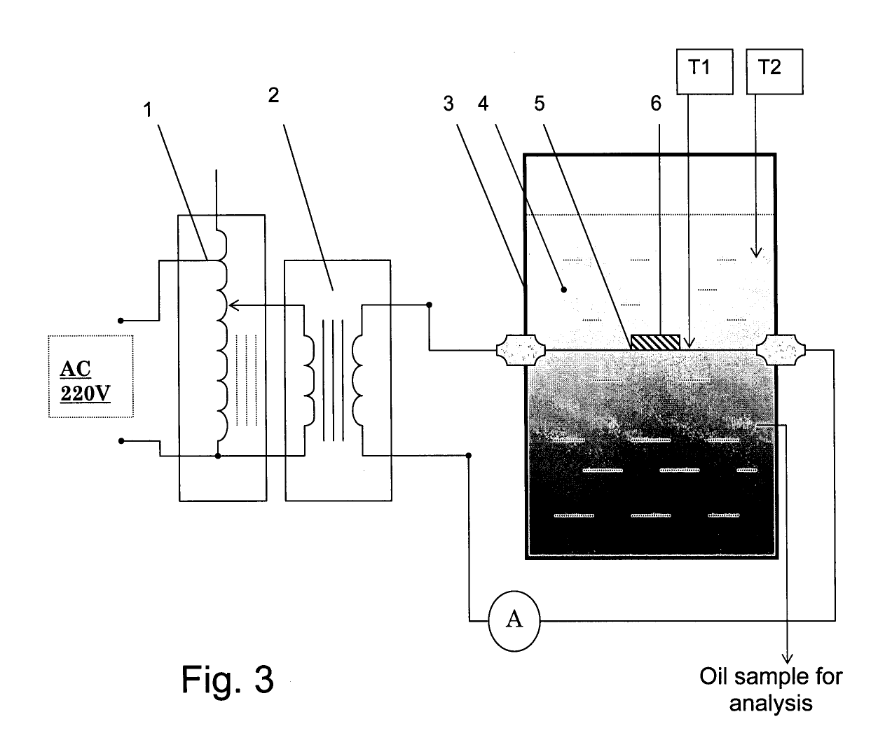

Testing of indicators on Laboratory Model of Electrical Device (LMED). Synthesized chemical indicators were tested on LMED, according to the scheme of FIG. 3.

The device (3) consists of volume, filled with mineral oil (4), with built-in heating plate (5), on which the chemical indicator (6) is applied. The heating plate receives voltage from loading transformer (2) and laboratory regulatory transformer (1). Ampermeter (A) controls the current on the heating plate. Thermocouple (T1) controls the temperature on the plate and thermocouple (T2) controls the temperature of the oil (Digital Thermometer NEWTRON TM-0113 Type K/J, ITS-90). Oil analysis for monomers is provided on a Gas Chromatograph Varian CP-3800 (Sensitivity: 0.2 ppm; relative error: 10%). Weighing of indicators was done on an analytical scale HR-300 with absolute error of ±0.3 mg. Weighting of transformer oil was provided on a technical scale WT-10K with error ±5 g.

The test procedure comprises the following steps:
a) three pieces of indicators N1, N2, and N3, ˜0.05 g each, weighted on analytical scale, were placed on the heating plate and tightened with glass-fiber strip;
b) the device was filled with mineral transformer oil (5950 g) and sealed with a hood with rubber sealing;
c) the temperature of the heating plate and oil was measured;
d) a control analysis of monomers content in the oil was done;
e) the heating plate was heated with current from a laboratory transformer, and the temperature of the heating plate was constantly controlled and raised by increasing the voltage. When the temperature reached 250° C., the voltage increase was stopped;
f) every 6 hours of heating, samples of oil were taken from LMED for analysis, to determine the content of methacrylate monomers; and
g) according to the results of the chromatographic analysis, the rate of thermal depolymerization of the chemical indicators was calculated according to:

D=(Cₙ−C₀)\C_{ind}×100,(%)

wherein:
D is the rate of thermal depolymerization of the indicator;
C₀ is the initial content of monomer in the oil, in ppm;
C_{ind} is the initial content of indicator in the oil, in ppm; and
Cₙ is the content of monomer in the oil after n hours of overheating, in ppm.

The results of the test are summarized in Table 7 below:

TABLE 7

| No. | Parameter | Ind. N1 | Ind. N2 | Ind. N3 |
|---|---|---|---|---|
| 1 | Weight of mineral Oil, g | 5950.0 | 5950.0 | 5950.0 |
| 2 | Initial Content of the indicators in Oil, ppm | 8.7 | 7.2 | 8.4 |
| 3 | Initial Concentration of monomer in mineral Oil, ppm | 0 | 0 | 0 |
| 4 | Concentration of monomer after 1 hour (250° C.), ppm | 1.3 | 0.6 | 1.6 |
| 5 | Concentration of monomer after 6 hours (250° C.), ppm | 4.3 | 4.1 | 5.3 |
| 6 | Concentration of monomer after 12 hours (250° C.), ppm | 6.0 | 5.0 | 6.7 |
| 7 | Concentration of monomer after 18 hours (250° C.), ppm | 6.9 | 6.2 | 7.3 |
| 8 | Concentration of monomer after 24 hours (250° C.), ppm | 7.3 | 6.3 | 7.5 |
| 9 | Destruction of the chemical indicator, % | 83.9 | 87.5 | 89.3 |
| 10 | Temperature of mineral Oil, in LMED, ° C. | 20-35 | 20-35 | 20-35 |
| 11 | Temperature on the Plate, ° C. | 250 ± 10 | 250 ± 10 | 250 ± 10 |

While the invention has been described in terms of some specific examples, many modifications and variations are possible. It is therefore understood that within the scope of the appended claims, the invention may be realized otherwise than as specifically described.

1. A method for identifying overheated spots in liquid-filled electrical devices, comprising the steps of:
a) determining the locations of potentially overheatable spots in said device and mapping said locations;
b) positioning a tag consisting of one or more chemical indicators on potentially overheatable spots in said devices, wherein when said tags are exposed to a given high temperature, they are depolymerized into thermal degradation products which are diffused into the liquid;
c) identifying the thermal degradation products by analytical methods; and
d) locating the overheated places according to the identified thermal degradation products and the map of locations of said tags;
wherein the tags comprise polymers and copolymers, which are substantially absent from the liquid of the device at normal working conditions.

2. A method according to claim 1, wherein in step (b), the tags are mounted on a heat-conducting elongation device, attached to a potentially overheatable place.

3. A method according to claim 1, wherein the liquid is an organic liquid.

4. A method according to claim 1, wherein the tags comprise a plurality of chemical indicators, each of which is depolymerized at a specific given temperature comprised between about 150° C. to about 450° C.

5. A method according to claim 1, wherein the tags have been microencapsulated.

6. A method according to claim 1, wherein the analytical methods used are chromatography or other analytical methods.

7. A method according to claim 1, wherein said tags degradate in oil at temperatures greater than 200° C.

8. A method according to claim 1, further comprising analyzing the dissolved substances in the liquid from the device periodically.

9. A method according to claim 1, wherein the identification of the overheated spot detected by the analysis of oil from a device, containing thermal degradation product is carried out according to a map of locations of the tags.

10. A chemical indicator (tag) comprising a polymer and/or copolymer, which are depolymerized when exposed to a temperature of from about 150° C. to about 450° C.

11. A tag according to claim 10, wherein the polymer has a quaternary carbon atom.

12. A tag according to claim 10, wherein the polymer is selected from among methyl-, ethyl-, propyl-, isopropyl-, butyl-, isobutyl-, methacrylonitril-methacrylates.

13. A tag according to claim 10, which is encapsulated.

14. A method for synthesis of a tag according to claim 10,
wherein the tag is microencapsulated, comprising the steps of:
a) mixing epoxy resins and polyamines;
b) mixing the mixture of step (a) with the polymer and pouring the mixture into a mould;
c) raising the temperature; and
d) further heating the indicator for removing monomer residues.
